(19) United States
(12) Patent Application Publication
(10) Pub. No.: US 2005/0014425 A1
(43) Pub. Date: Jan. 20, 2005

(54) Drive system for amphibious equipment

(76) Inventor: Paul K. Wilson, Westwego, LA (US)

Correspondence Address: MICHAEL D CARBO, PLC, 700 WHITNEY BANK BUILDING, 228 ST CHARLES AVENUE, NEW ORLEANS, LA, 70130, US

(21) Appl. No.: 10/618,927

(22) Filed: Jul. 14, 2003

(51) Int. Cl. B63H 1/00; B60F 3/00; B63H 19/08

(52) U.S. Cl. 440/12.56; 440/12.63

(57) ABSTRACT

A track-drive assembly for use in amphibious craft includes track sprockets affixed to a shaft, a track-drive sprocket removably attached to the shaft at or near an end thereof, and a bearing disposed on the shaft between the track-drive sprocket and the track sprockets. The location of the track-drive sprocket and the relative position of the bearing and the sprockets renders the track-drive sprocket easily replaceable in the field with a different diameter sprocket to allow the craft to be used in both normal and marshy environments. The track-drive assembly can be used with conventional final drives of hydraulically-driven amphibious machinery.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

The present invention relates to hydraulically-driven, amphibious excavators and draglines and more particularly, to an easily adjustable and changeable sprocket-and-chain drive system for hydraulically driven, low ground-pressure amphibious excavators and draglines having caterpillar-type treads or tracks.

A conventional self-propelled machine sometimes travels on endless belts, having attached thereon or consisting of a series of flat treads or tracks, with one or more belts on each side of the machine. The belts are kept in motion by toothed driving wheels, driven by a prime mover, so that the machine turns and moves forward or backward with the revolution of the belts. This type of self-propelled machinery is often called caterpillar-type machinery. Conventional self-propelled excavators and draglines have been fitted with pontoon-supported tracks to provide buoyancy and low ground pressure for operation in amphibious and marshy environments. Each pontoon is disposed within the area enclosed by an endless belt of the caterpillar tread or tracks.

In amphibious or marshy environments, a conventional drive system of an excavator or dragline can be used to operate the working machinery, but larger, pontoon-supported tracks must be used to effect lower ground pressure to avoid sinking and getting stuck in soft or sticky ground. Ground pressure in the range of approximately 1 psi to approximately 1.5 psi are considered to be sufficiently low for working in muck and mire. Standard ground pressure for conventional equipment varies but is usually approximately 8 psi or above. For example, a standard land excavator exerts a ground pressure of approximately 8 psi. When larger tracks are used, greater track force is required to accommodate the increased weight of the tracks, to propel the excavator or dragline over sticky, muddy environments, and to allow the excavator or dragline to climb out of canals and over embankments.

As previously described, tracked vehicles such as marsh buggies and other amphibious crawlers are typically driven by means of an endless track arrangement which surrounds a pontoon and is driven about the outer surface of the pontoon by means of a hydraulic motor. In conventional designs, the hydraulic motor is interengaged with the endless track by means of a chain drive which transfers the power generated by the hydraulic motor to a separate independent track drive assembly which, in turn, drives one or more track chains to operate the endless drive. A typical marsh buggy has from two to five track chains which connect the cleats of the endless drive. An example of this sort of chain-drive arrangement is disclosed in U.S. Pat. Nos. 3,842,785 and 4,124,124, both to Rivet. See, for example, U.S. Pat. No. 3,842,785, at FIGS. 2 and 7, column 2, lines 17-40, and column 3, lines 24-39. See also U.S. Pat. No. 4,124,124, at FIGS. 2 and 9 and column 1, lines 62-65.

The chain-drive arrangement shown in the patents to Rivet has a track-drive sprocket and also has track sprockets referred to as drive sprockets (17), mounted on shafts (16), where each shaft is journaled in bearings (18). However, all sprockets are located between the two bearings. Consequently, changing a drive sprocket involves, among other things, removing a bearing.

To provide greater track force for pontoon-supported tracks, some attempts have been made to use a separate engine to power the tracks. However, the use of a separate engine to power the tracks adds to both the weight and the cost. Increased weight requires a proportional increase in the size of the separate engine over what otherwise would be sufficient to power the tracks if a single engine were used to power both the tracks and the working machinery. Additionally, increased weight can require larger pontoons to float the machinery. The use of a separate engine to power the tracks also requires increased time and costs for maintenance. Consequently, the use of a separate engine to power the tracks of a pontoon-supported hydraulically-driven amphibious excavator and dragline is less desireable than the use of a single engine to power both the working machinery and the tracks.

In attempting to use a single engine to power both the working machinery and the tracks, conventional track motors and brakes of an excavator, such as a Caterpillar 325 excavator (Caterpillar Corporation, Peoria, Ill.), have been used with a specially-adapted after-market planetary gear or planet differential. While this specially-adapted planetary gear does achieve increased track force necessary to drive pontoon-supported tracks on an excavator in an amphibious or other low ground-pressure environment, the planetary gear increases weight and cost substantially.

More recently, U.S. Pat. No. 4,817,554, issued to Prestenbach, disclosed the use of a drive shaft assembly from an excavator connected directly to an axle of the tracks of an amphibious vehicle. Although this direct-drive configuration allows a single engine to power the working machinery and to drive the tracks, only a fixed track force is produced. This fixed track force is the same track force that is produced by a conventional excavator or dragline engine for conventional land tracks and is insufficient to generate the greater track force necessary for operation in amphibious and marshy environments where larger tracks are used to achieve low ground pressure to avoid getting stuck. The drive shaft assembly disclosed in U.S. Pat. No. 4,817,554 to Prestenbach does not allow gearing up or down. Consequently, the engine must be sized to develop the power and driving force necessary at a single gear ratio.

U.S. Pat. No. 6,482,053 to Prestenbach discloses a tail drive sprocket assembly driven by a hydraulically-actuated motor attached to a fully enclosed internal gear reducer. See, for example, FIGS. 11-15 and column 4, lines 21-67. However, this tail drive sprocket assembly is enclosed and is therefore difficult to lubricate effectively and not easily changeable in the field.

U.S. Pat. No. 5,740,875 to Wilson, Sr., et al. discloses drive sprockets bolted or otherwise affixed to an outer shaft sleeve that, in turn, is keyed to an inner shaft. A disadvantage of this arrangement is that, in order to replace a sprocket, a pillow block must first be removed and a gear box must also be removed from its attachment to a wall. Another disadvantage of this arrangement is that the drive has an after-market planetary.

None of the above-described track drives, taken either alone or in combination, describes the present invention as claimed. The present invention contemplates a final drive, also called a motor drive, that is common to excavators, draglines, bulldozers, and other caterpillar-type machinery, but that does not need to be modified with an after-market planetary gear for use in amphibious, marshy, or other environments requiring machinery that exerts low pressure on the ground. The present invention also contemplates an adjustable and easily changeable sprocket-and-chain assembly that overcomes some of the disadvantages and deficiencies in the prior art.

### SUMMARY OF THE INVENTION

The present invention is an improved drive system for use in amphibious excavators and draglines having caterpillar-type treads or tracks. The invention is an adjustable sprocket-and-chain connection between the final drive of an engine and the track axle that moves the endless belts containing the tracks or treads to propel the machinery.

The improved drive system of the present invention has a sprocket attached to the final drive of the motor, a sprocket removably affixed to a track drive axle near or at an end thereof, and an endless chain connecting the motor-drive sprocket and the track-drive sprocket. The sprocket-and-chain drive system can be adjusted to change torque and speed by removing and replacing the track-drive sprocket with a greater diameter sprocket for more track force and lower speed or with a lesser diameter sprocket for less track force and higher speed.

The track-drive sprocket is preferably a flat plate type sprocket attached to a track shaft or axle by means of a keyway and set screw. The shaft or axle also contains track sprockets that engage the tracks or treads of the endless belts. These track sprockets are preferably welded to the track shaft or axle. The track-drive sprocket is located on an end of the track shaft or axle and receives, via an endless chain, power generated by the motor.

In a preferred embodiment of the invention, the track shaft or axle is journaled in a bearing that is disposed between the track-drive sprocket and the track sprockets. The bearing adds support to the track shaft or axle between the track-drive sprocket and the track sprockets.

The final drives of the engine are preferably positioned for easy access to oil drain plugs and the reservoir.

Accordingly, it is an object of the present invention to provide an improved track-drive assembly for caterpillar-type machinery to allow for operation and propulsion of the machinery in amphibious environments.

It is another object of this invention to provide a chain-and-sprocket drive system that can be easily adjusted by changing out a track-drive sprocket on each pontoon to change the torque and speed of each track axle.

It is a further object of the invention to provide a drive system that does not require the use of an after-market planetary gear.

Still another object of the present invention is to provide a drive system that can be positioned to allow for easy access to oil drain plugs and to fluid reservoirs.

It is another object of the present invention to provide a drive system for use with conventional final drives of excavators, draglines, bulldozers, and other caterpillar-type machinery, and that can be serviced in the field by service personnel familiar with conventional final drives.

Still another object of this invention is to provide improved elements and arrangements of an adjustable sprocket-and-chain drive system for use in propelling caterpillar-type machinery for the purposes described and which drive system is inexpensive, dependable, and effective in accomplishing its intended purposes.

These and other object of the present invention will become readily apparent upon review of the following specification and drawing figures.

### BRIEF DESCRIPTION OF THE DRAWING

Reference will now be made to the drawing figures, wherein like parts are designated by like numerals, and wherein

FIG. 1 is a perspective view of an amphibious craft showing a track-drive assembly according to an embodiment of the invention.

FIG. 2 is a top view of a portion of a portion showing the track-drive sprocket, the bearing, and the drive motor, with the chain removed for ease of viewing.

FIG. 3 is a top view of an embodiment of a track-drive axle showing a preferred embodiment of an axle, a track-drive sprocket, a bearing, two track sprockets.

FIG. 4 is a top view of an embodiment of a track-drive axle showing its relation to a final drive on the end of a portion.

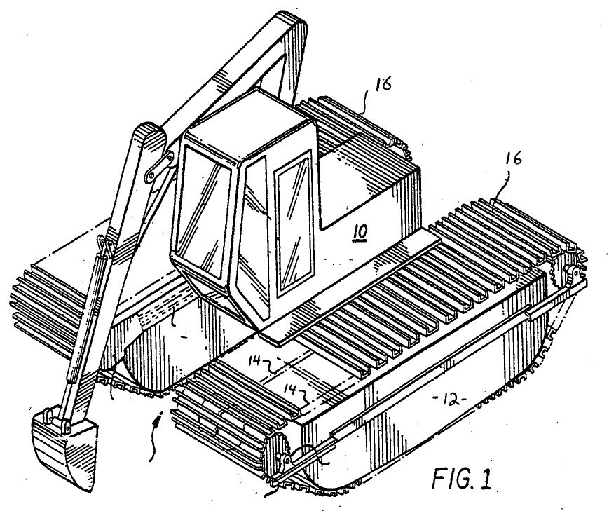

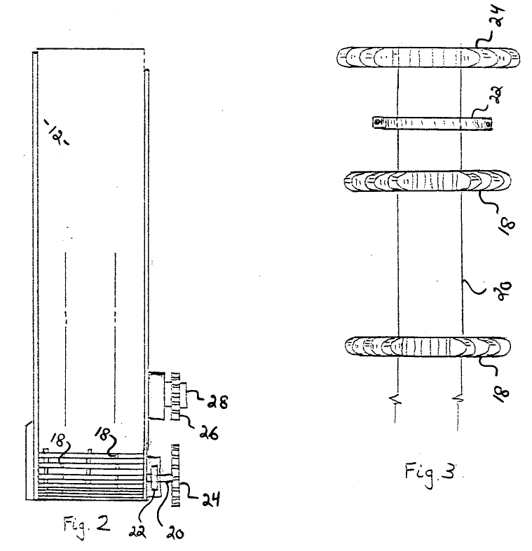

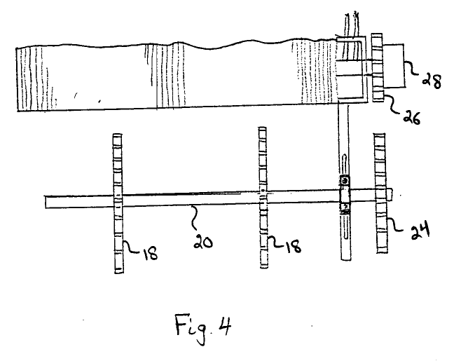

### DETAILED DESCRIPTION OF THE INVENTION

Referring now to the drawing figures in more detail, an amphibious, self-propelled caterpillar-type machine 10 is illustrated. Machine 10 has pontoons 12 disposed one on each side of machine 10. Each pontoon 12 has at least one endless chain 14, to which are attached a series of tracks 16. Preferably, each pontoon has at least two endless chains 14 disposed near the opposite ends of tracks 16, and can have three or more endless chains.

Endless chains 14 are driven via track sprockets 18 welded or bolted onto track axle 20, also called a shaft. Track axle 20 is driven by an endless chain (not shown) connected to track-axle sprocket 24, which is preferably key set onto track axle 20. The endless chain is connected to motor-drive sprocket 26, also called a final drive sprocket, which is connected, preferably bolted, to final drive 28 of a prime mover, preferably an engine. Track-axle sprocket 24 can be easily removed and replaced in the field. Even if the track-drive sprocket 24 is fused to track axle 20 because of corrosion, a portable hydraulic power pack can be used in the field to remove the track-drive sprocket from the track axle with the necessity for removing a bearing or pillow block.

For operation on land, the size of each track-axle sprocket 24 is usually selected to achieve normal propulsive track force and consequent normal speed. For operation in marsh or in other soft or sticky environments, track-axle sprocket 24 is removed and replaced with a track-axle sprocket having a larger diameter, typically 30 inches to 40 inches or more in diameter, thereby gearing down the track drive system. This gearing down of the track drive allows a single engine, sized for optimum performance of the working machinery, to be used to provide sufficient torque to propel the machinery through sticky, muddy environments, out of canals, and over embankments.

The endless chain preferably has a master link, that can be disassembled and reassembled in the field.

It will be understood to those having ordinary skill that the present invention is not limited to the embodiments described and shown herein but that the present invention encompasses any and all embodiments within the scope of the following chains.

1. In an amphibious craft having a pair of spaced, elongated pontoons, each pontoon having (i) an endless track guided around the periphery thereof; (ii) a hydraulic motor having a stationary part attached to the pontoon and having a motor-drive sprocket; (iii) a track-drive assembly for driving the endless track; and (iv) a chain assembly for transferring power generated by the motor to the track-drive assembly; an improved track-drive assembly, comprising:
a shaft, a track-drive sprocket removably attached to the shaft near or at an end thereof, at least one track sprocket attached to the shaft, and a journaled bearing disposed on the shaft between the track-drive sprocket and the at least one track sprocket.

2. A track-drive assembly for amphibious craft, the track-drive assembly comprising:
a shaft; at least one track sprocket affixed to the shaft; a track-drive sprocket removably affixed to the shaft near or at an end thereof; and a shaft bearing disposed between the track-drive sprocket and the at least one track sprocket.
